(19) United States
(12) Patent Application Publication
(10) Pub. No.: US 2020/0334969 A1
(43) Pub. Date: Oct. 22, 2020

(54) Child Water Safety Bracelet System

(71) Applicant: Kathryn Harris, Bedford, NH (US)

(72) Inventor: Kathryn Harris, Bedford, NH (US)

(21) Appl. No.: 16/387,038

(22) Filed: Apr. 17, 2019

(51) Int. Cl. G08B 21/08; B63C 9/00; E04H 4/06

(52) U.S. Cl. CPC G08B 21/088; E04H 4/06; B63C 9/0005

(57) ABSTRACT

A child water safety bracelet system for alerting parents to their children's entering water includes at least one child bracelet and a parent bracelet. The child bracelet comprises a first housing and a first wristband configured to secure the first housing to a child's wrist. A water sensor, a first CPU, a first battery, and a transmitter are coupled within a first inner cavity of the first housing. The first CPU sends an alarm signal through the transmitter when the water sensor detects water. The parent bracelet comprises a second housing and a second wristband configured to secure the second housing to a parent's wrist. A speaker, a second CPU, a second battery, and a receiver are coupled within a second inner cavity of the second housing. The second CPU activates the speaker to produce the alarm sound when the receiver receives the alarm signal from the transmitter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to child water safety devices and more particularly pertains to a new child water safety device for alerting parents to their children's entering water.

### BRIEF SUMMARY OF THE INVENTION

An embodiment of the disclosure meets the needs presented above by generally comprising at least one child bracelet and a parent bracelet. The child bracelet comprises a first housing having a first top side separated from a first bottom side, a first front side separated from a first back side, and a first left side separated from a first right side to form a first inner cavity. The top side has a plurality of water apertures extending through to the first inner cavity. A water sensor is coupled within the first inner cavity below the water apertures and is configured to detect the presence of water. A first CPU is coupled within the first inner cavity and is in operational communication with the water sensor. A first battery is coupled within the first inner cavity and is in operational communication with the first CPU. A transmitter is coupled within the first inner cavity and is in operational communication with the first CPU. The first CPU sends an alarm signal through the transmitter when the water sensor detects water. A first wristband comprises a first left band and a first right band coupled to the first left side and the first right side, respectively. Each of the first left band and the first right band have a first engagement mechanism proximal a first distal end thereof. The first engagement mechanisms of the first left band and the first right band are selectively engageable to secure the first housing to a child's wrist. The parent bracelet comprises a second housing having a second top side separated from a second bottom side, a second front side separated from a second back side, and a second left side separated from a second right side to form a second inner cavity. The top side has a plurality of speaker grille apertures extending through to the second inner cavity. A speaker is coupled within the second inner cavity below the speaker grille apertures and emits an alarm sound when activated. A second CPU is coupled within the second inner cavity and is in operational communication with the speaker. A second battery is coupled within the second inner cavity and is in operational communication with the second CPU. A receiver is coupled within the second inner cavity and is in operational communication with the second CPU and the transmitter of the child bracelet. The second CPU activates the speaker to produce the alarm sound when the receiver receives the alarm signal from the transmitter. A second wristband comprises a second left band and a second right band coupled to the second left side and the second right side, respectively. Each of the second left band and the second right band have a second engagement mechanism proximal a second distal end thereof, the second engagement mechanisms of the second left band and the second right band are selectively engageable to secure the second housing to a parent's wrist.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a child water safety bracelet system according to an embodiment of the disclosure.

FIG. 2 is a top plan view of an embodiment of the disclosure.

FIG. 3 is an in-use view of an embodiment of the disclosure.

FIG. 4 is a block diagram of an embodiment of the disclosure.

### DETAILED DESCRIPTION OF THE INVENTION

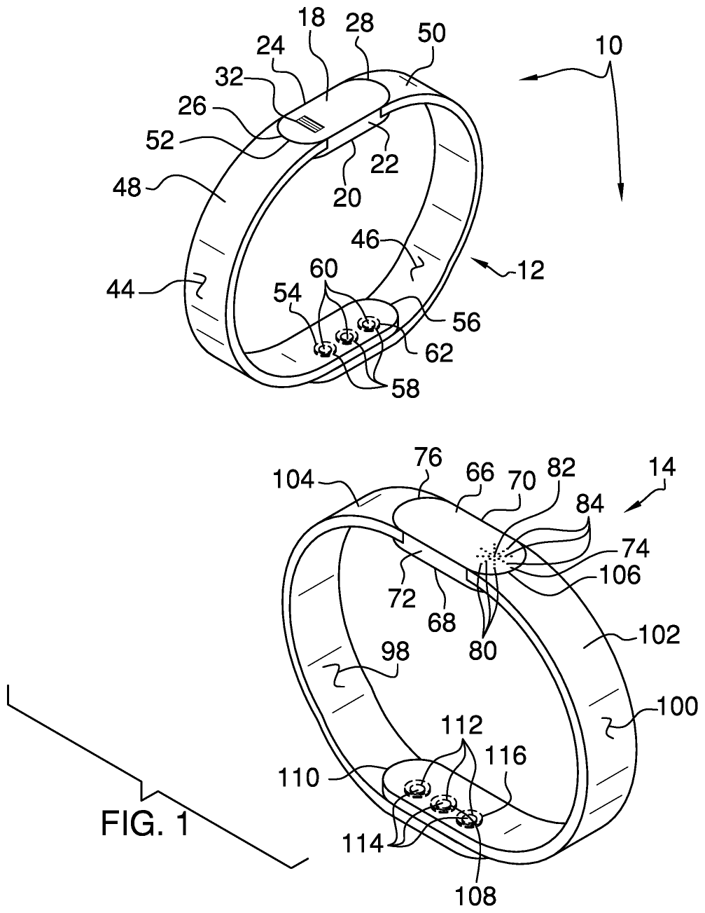

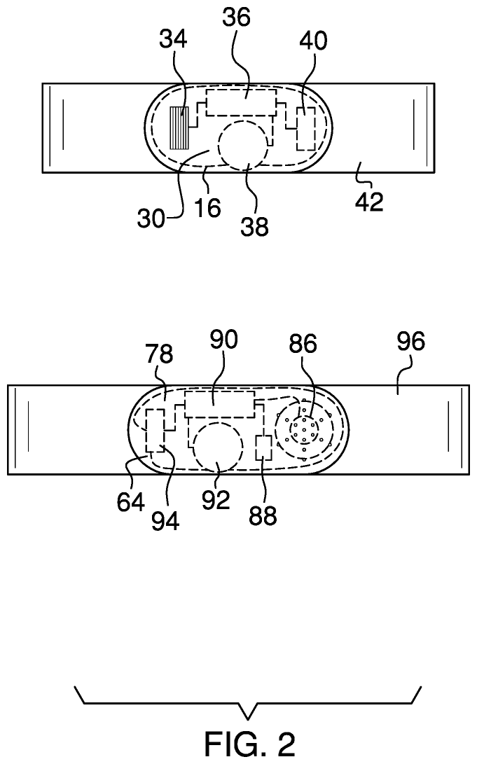

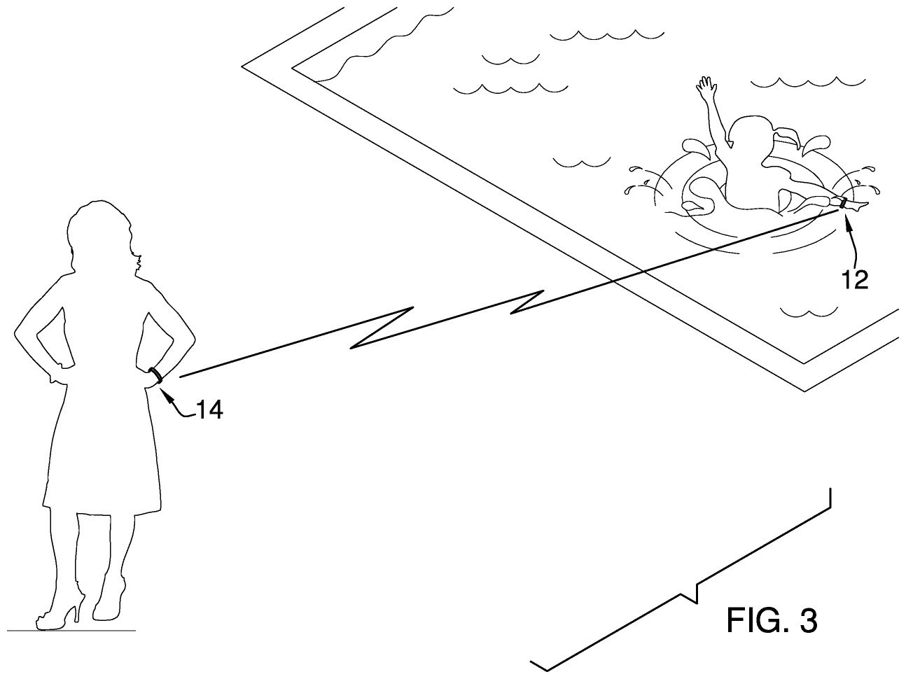

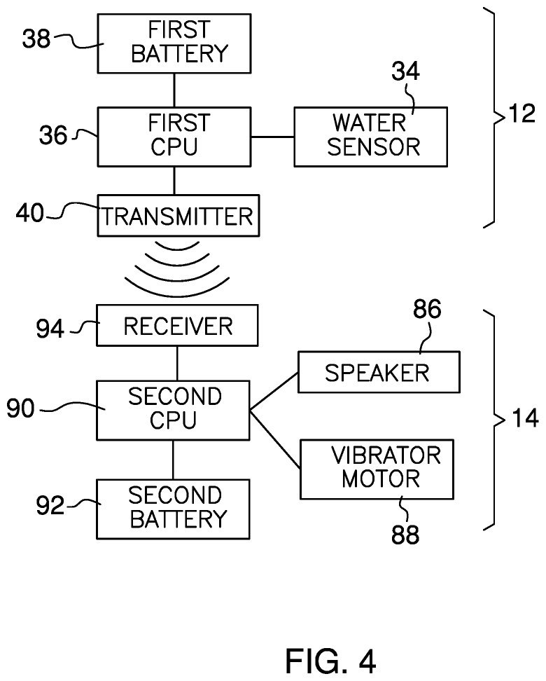

With reference now to the drawings, and in particular to FIGS. 1 through 4 thereof, a new child water safety device embodying the principles and concepts of an embodiment of the disclosure and generally designated by the reference numeral 10 will be described.

As best illustrated in FIGS. 1 through 4, the child water safety bracelet system 10 generally comprises at least one child bracelet 12 and a parent bracelet 14. The child bracelet 12 comprises a first housing 16 having a first top side 18 separated from a first bottom side 20, a first front side 22 separated from a first back side 24, and a semicircular first left side 26 separated from a semicircular first right side 28 to form a first inner cavity 30. The first top side 18 has a plurality of water apertures 32 extending through to the first inner cavity 30. The plurality of water apertures 32 may be a plurality of parallel slots. A water sensor 34 is coupled within the first inner cavity 30 below the water apertures 32 and is configured to detect the presence of water. A first CPU 36, a first battery 38, and a transmitter 40 are coupled within the first inner cavity 30 and are in operational communication with the water sensor 34.

A first wristband 42 is coupled to the first housing 16. The first wristband 42 has a first outside face 44 and a first inside face 46. The first wristband 42 comprises a first left band 48 and a first right band 50 each having a first proximal end 52 coupled to the first left side 26 and the first right side 28, respectively. The first proximal end 52 has concave curvature corresponding with the first left side 26 and the first right side 28. The first outside face 44 at the first proximal end 52 of each of the first left band 48 and the first right band 50 is coplanar with the first top side 18. Each of the first left band 48 and the first right band 50 has a first engagement mechanism 54 proximal a first distal end 56 thereof. The first engagement mechanism 54 of the first left band 48 is a plurality of first snap apertures 58 extending from the first outside face 44 through the first inside face 46. The first engagement mechanism 54 of the first right band 48 is a plurality of first snap protrusions 60 coupled to the first inside face 46. Each of the plurality of first snap protrusions 60 is selectively engageable with the plurality of first snap apertures 58. The plurality of first snap apertures 58 and the plurality of first snap protrusions 60 may be a linear array of three. Each of the plurality of first snap apertures 58 has a first recessed perimeter 62 on the first inside face 46. The first snap protrusions 60 extend past the first recessed perimeter 62 but below the first inside face 46 when engaged to prevent user discomfort. The first engagement mechanisms 54 of the first left band 48 and the first right band 50 are configured to secure the first housing 16 to a child's wrist. Any combination of first snap apertures 58 and first snap protrusions 60 may be used to create different fits.

The parent bracelet 14 comprises a second housing 64 having a second top side 66 separated from a second bottom side 68, a second front side 70 separated from a second back side 72, and a semicircular second left side 74 separated from a semicircular second right side 76 to form a second inner cavity 78. The second top side 66 has a plurality of speaker grille apertures 80 extending through to the second inner cavity 78. The plurality of speaker grille apertures 80 comprises a central aperture 82 and a plurality of radially extending aperture arrays 84. There may be eight aperture arrays 84 spaced 45° apart to create even distribution of sound. A speaker 86 is coupled within the second inner cavity 78 below the speaker grille apertures 80 and emits an alarm sound when activated. A vibrator motor 88 is coupled within the second inner cavity 78 and produces a haptic alarm notification when activated. A second CPU 90, a second battery 92, and a receiver 94 are coupled within the second inner cavity 78 and are in operational communication with the speaker 86 and the vibrator motor 88. The receiver 94 is in operational communication with the transmitter 40 of the child bracelet.

A second wristband 96 is coupled to the second housing 64. The second wristband 96 has a second inside face 98 and a second outside face 100. The second wristband 96 comprises a second left band 102 and a second right band 104 each having a second proximal end 106 coupled to the second left side 74 and the second right side 76, respectively. The second proximal end 106 has concave curvature corresponding with the second left side 74 and the second right side 76. The second outside face 100 at the second proximal end 106 of each of the second left band 102 and the second right band 104 is coplanar with the second top side 66. Each of the second left band 102 and the second right band 104 has a second engagement mechanism 108 proximal a second distal end 110 thereof. The second engagement mechanism 108 of the second left band 102 is a plurality of second snap apertures 112 extending from the second outside face 100 through the second inside face 98. The second engagement mechanism 108 of the second right band 104 is a plurality of second snap protrusions 114 coupled to the second inside face 98. Each of the plurality of second snap protrusions 114 is selectively engageable with the plurality of second snap apertures 112. Each of the plurality of second snap apertures 112 has a second recessed perimeter 116 on the second inside face 98. The second snap protrusions 114 extend past the second recessed perimeter 116 but below the second inside face 98 when engaged to prevent user discomfort. The second engagement mechanisms 108 of the second left band 102 and the second right band 104 are configured to secure the second housing 64 to a parent's wrist. Any combination of second snap apertures 112 and second snap protrusions 114 may be used to create different fits.

In use, the child bracelet 12 is worn by the child and the parent bracelet 14 is worn by the parent or guardian. Should the child jump or fall into a pool or other body of water, the first CPU 36 sends an alarm signal through the transmitter 40 when the water sensor 34 detects water. The second CPU 90 activates the speaker 86 to produce the alarm sound and the vibrator motor 88 to produce the haptic alarm notification when the receiver 94 receives the alarm signal from the transmitter 40. The parent or guardian can thus be notified to go help or supervise the child.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A child water safety bracelet system comprising:
at least one child bracelet, the child bracelet comprising:
a first housing, the first housing having a first top side separated from a first bottom side, a first front side separated from a first back side, and a first left side separated from a first right side to form a first inner cavity, the first top side having a plurality of water apertures extending through to the first inner cavity;
a water sensor coupled to the first housing, the water sensor being coupled within the first inner cavity below the water apertures and configured to detect the presence of water;
a first CPU coupled to the first housing, the first CPU being coupled within the first inner cavity and in operational communication with the water sensor;
a first battery coupled to the first housing, the first battery being coupled within the first inner cavity and in operational communication with the first CPU;
a transmitter coupled to the first housing, the transmitter being coupled within the first inner cavity and in operational communication with the first CPU, the first CPU sending an alarm signal through the transmitter when the water sensor detects water; and
a first wristband coupled to the first housing, the first wristband comprising a first left band and a first right band coupled to the first left side and the first right side, respectively, each of the first left band and the first right band having a first engagement mechanism proximal a first distal end thereof, the first engagement mechanisms of the first left band and the first right band being selectively engageable to secure the first housing to a child's wrist; and
a parent bracelet, the parent bracelet comprising:
a second housing, the second housing having a second top side separated from a second bottom side, a second front side separated from a second back side, and a second left side separated from a second right side to form a second inner cavity, the second top side having a plurality of speaker grille apertures extending through to the second inner cavity;
a speaker coupled to the second housing, the speaker being coupled within the second inner cavity below the speaker grille apertures and emitting an alarm sound when activated;
a second CPU coupled to the second housing, the second CPU being coupled within the second inner cavity and in operational communication with the speaker;
a second battery coupled to the second housing, the second battery being coupled within the second inner cavity and in operational communication with the second CPU;
a receiver coupled to the second housing, the receiver being coupled within the second inner cavity and in operational communication with the second CPU and the transmitter of the child bracelet, the second CPU activating the speaker to produce the alarm sound when the receiver receives the alarm signal from the transmitter; and
a second wristband coupled to the second housing, the second wristband comprising a second left band and a second right band coupled to the second left side and the second right side, respectively, each of the second left band and the second right band having a second engagement mechanism proximal a second distal end thereof, the second engagement mechanisms of the second left band and the second right band being selectively engageable to secure the second housing to a parent's wrist.

2. The child water safety bracelet system of claim 1 further comprising a vibrator motor coupled to the second housing, the vibrator motor being coupled within the second inner cavity and in operational communication with the second CPU, the CPU activating the vibrator motor simultaneously with the speaker to produce a haptic alarm notification.

3. The child water safety bracelet system of claim 1 further comprising each of the first left end, the first right end, the second left end, and the second right end being semicircular, a first proximal end of each of the first left band and the first right band and a second proximal end of each of the second left band and the second right band having concave curvature corresponding with the first left end, the first right end, the second left end, and the second right end, respectively.

4. The child water safety bracelet system of claim 1 further comprising a first outside and a second face of each of the first left band, the first right band, the second left band, and the second right band, respectively, being coplanar with the first top side and the second top side, respectively.

5. The child water safety bracelet system of claim 1 further comprising the first and second engagement mechanisms of the first left band and the second left band being a plurality of first snap apertures and second snap apertures extending from the first outside face through a first inside face and through the second outside face through a second inside face, respectively, the first and second engagement mechanisms of the first right band and the second right band being a plurality of first snap protrusions and second snap protrusions coupled to the first inside face and the second inside face, respectively, each of the plurality of first and second snap protrusions being selectively engageable with the plurality of first and second snap apertures, respectively.

6. The child water safety bracelet system of claim 5 further comprising each of the plurality of first and second snap apertures having a first and second recessed perimeter on the first and second inside face, respectively, the plurality of first and second snap protrusions extending past the first and second recessed perimeter but below the first and second inside face, respectively, when engaged.

7. The child water safety bracelet system of claim 1 further comprising the plurality of water apertures being a plurality of parallel slots.

8. The child water safety bracelet system of claim 1 further comprising the plurality of speaker grille apertures comprising a central aperture and a plurality of radially extending aperture arrays.

9. The child water safety bracelet system of claim 8 further comprising the plurality of radially extending aperture arrays being eight arrays spaced 45° apart.

10. A child water safety bracelet system comprising:
at least one child bracelet, the child bracelet comprising:
a first housing, the first housing having a first top side separated from a first bottom side, a first front side separated from a first back side, and a semicircular first left side separated from a semicircular first right side to form a first inner cavity, the first top side having a plurality of water apertures extending through to the first inner cavity, the plurality of water apertures being a plurality of parallel slots;
a water sensor coupled to the first housing, the water sensor being coupled within the first inner cavity below the water apertures and configured to detect the presence of water;
a first CPU coupled to the first housing, the first CPU being coupled within the first inner cavity and in operational communication with the water sensor;
a first battery coupled to the first housing, the first battery being coupled within the first inner cavity and in operational communication with the first CPU;
a transmitter coupled to the first housing, the transmitter being coupled within the first inner cavity and in operational communication with the first CPU, the first CPU sending an alarm signal through the transmitter when the water sensor detects water; and
a first wristband coupled to the first housing, the first wristband having a first outside face and a first inside face, the first wristband comprising a first left band and a first right band each having a first proximal end coupled to the first left side and the first right side, respectively, the first proximal end having concave curvature corresponding with the first left side and the first right side, the first outside face at the first proximal end of each of the first left band and the first right band being coplanar with the first top side, each of the first left band and the first right band having a first engagement mechanism proximal a first distal end thereof, the first engagement mechanism of the first left band being a plurality of first snap apertures extending from the first outside face through the first inside face, the first engagement mechanism of the first right band being a plurality of first snap protrusions coupled to the first inside face, each of the plurality of first snap protrusions being selectively engageable with the plurality of first snap apertures, each of the plurality of first snap apertures having a first recessed perimeter on the first inside face, the plurality of first snap protrusions extending past the first recessed perimeter but below the first inside face when engaged, the first engagement mechanisms of the first left band and the first right band being configured to secure the first housing to a child's wrist; and
a parent bracelet, the parent bracelet comprising:
a second housing, the second housing having a second top side separated from a second bottom side, a second front side separated from a second back side, and a semicircular second left side separated from a semicircular second right side to form a second inner cavity, the second top side having a plurality of speaker grille apertures extending through to the second inner cavity, the plurality of speaker grille apertures comprising a central aperture and a plurality of radially extending aperture arrays, the plurality of radially extending aperture arrays being eight arrays spaced 45° apart;
a speaker coupled to the second housing, the speaker being coupled within the second inner cavity below the speaker grille apertures and emitting an alarm sound when activated;
a vibrator motor coupled to the second housing, the vibrator motor being coupled within the second inner cavity and producing a haptic alarm notification when activated;
a second CPU coupled to the second housing, the second CPU being coupled within the second inner cavity and in operational communication with the speaker and the vibrator motor;
a second battery coupled to the second housing, the second battery being coupled within the second inner cavity and in operational communication with the second CPU;
a receiver coupled to the second housing, the receiver being coupled within the second inner cavity and in operational communication with the second CPU and the transmitter of the child bracelet, the second CPU activating the speaker to produce the alarm sound and the vibrator motor to produce the haptic alarm notification when the receiver receives the alarm signal from the transmitter; and
a second wristband coupled to the second housing, the second wristband having a second inside face and a second outside face, the second wristband comprising a second left band and a second right band each having a second proximal end coupled to the second left side and the second right side, respectively, the second proximal end having concave curvature corresponding with the second left side and the second right side, the second outside face at the second proximal end of each of the second left band and the second right band being coplanar with the second top side, each of the second left band and the second right band having a second engagement mechanism proximal a second distal end thereof, the second engagement mechanism of the second left band being a plurality of second snap apertures extending from the second outside face through the second inside face, the second engagement mechanism of the second right band being a plurality of second snap protrusions coupled to the second inside face, each of the plurality of second snap protrusions being selectively engageable with the plurality of second snap apertures, each of the plurality of second snap apertures having a second recessed perimeter on the second inside face, the plurality of second snap protrusions extending past the second recessed perimeter but below the second inside face when engaged, the second engagement mechanisms of the second left band and the second right band being configured to secure the second housing to a parent's wrist.
